(19) United States
(12) Patent Application Publication
(10) Pub. No.: US 2005/0022444 A1
(43) Pub. Date: Feb. 3, 2005

(54) Insect-trapping condensing system

(76) Inventor: James D. Maddigan, Cudahy, WI (US)

Correspondence Address: WHYTE HIRSCHBOECK DUDEK S C, 555 EAST WELLS STREET, SUITE 1900, MILWAUKEE, WI, 53202, US

(21) Appl. No.: 10/884,419

(22) Filed: Jul. 2, 2004

Related U.S. Application Data
(60) Provisional application No. 60/486,957, filed on Jul. 14, 2003.

(51) Int. Cl. A01M 1/06

(52) U.S. Cl. 43/139

(57) ABSTRACT

An insect-trapping condensing system is disclosed herein. The system comprises: a housing defining an interior space; an acoustic wave generator for generating acoustic soundwaves; a baffle located within the interior space and having channels formed in the baffle for distributing the soundwaves; and a condensing unit within the interior space for condensing a refrigerant and having a fin structure for trapping insects. The system condensing unit receives the soundwaves generated by the wave generator and distributed by the channels in the baffle. The wave generator mimics the heartbeat rate range for people and therefore can act as a sonic insect attractant by simulating the human heart. In general, the invention utilizes condensing functionality to provide an insect-trapping system, thereby providing a solution to a previously unfilled need.

### CROSS REFERENCE TO RELATED APPLICATIONS

This application claims the benefit of U.S. Provisional Application Ser. No. 60/486,957 filed Jul. 14, 2003, the teachings and disclosures of which are herein incorporated by reference.

### BACKGROUND OF THE INVENTION

The invention relates generally to insect control and management, and more particularly, to a device having insect attracting and trapping capabilities.

It is a continuing goal to reduce the presence of insect pests around the exterior area of the household environment where people are most active and spend a large portion of their time. Given the attention given to viruses and other illnesses brought on by airborne insects, the reduction in the presence of such insects in a specific area has been of interest.

Many home owners use some sort of air conditioning or similar unit that has a condenser located just outside the home that takes in air from the outside and uses that air to provide cooling to elements that are heated during the refrigeration process associated with air conditioning.

Therefore, it would be desirable to utilize a unit that many homeowners already have or use in order to provide the additional functionality of reducing unwanted insects around the areas of the home exterior. In such a case, it would be beneficial to be able to use units that are already located in the same general area that it is desired to reduce the insect population.

It has been known to use sonic wave type technology, which mimics a regular human heartbeat pattern discernible by the insects, as well as chemical and gaseous attractants, such as CO₂, along with partial vacuum devices to attract and trap insects, such as in U.S. Pat. Nos. 6,467,215 and 5,241,778. Oftentimes such devices are combined with sticky glue-like substances to adhere to and trap the insects, which require clean-up and replacement when the insects are removed. These devices are single purpose in nature and are not intended for use with existing air conditioning technology.

There would be an economic benefit to utilizing the insect attractant capabilities of the sonic technology and associating it with condenser units already generally found about the home exterior, particularly since the condenser provides a screened or finned vacuum air intake to trap insects attracted to the condenser by the sonic technology.

Also, it is also a common occurrence that condensers and other units that utilize intake ambient air in an outside environment often will, upon continued use, become clogged or otherwise partially blocked due to the particulate, airborne matter and insects that become lodged in the air intake passageways of the condenser units. One result from this occurrence is the reduction in the air flow and cooling efficiencies of such units, increasing the work and operating expense of the unit to achieve its intended functionality, resulting in higher utility bills. It has long been encouraged by manufacturers of condenser/air conditioning units and others to periodically clean the units as part of a regular maintenance plan to increase the efficiency of the refrigeration process associated with the units. However, actual cleaning of such units is generally conducted between longer time periods, if at all, than is optimal for proper unit performance. A general benefit would accrue to users/owners of such units by having a specific incentive for regular cleaning and maintenance of the unit intakes.

Therefore, a combination condensing unit and sonic wave insect control device which solves the aforementioned needs would be seen as beneficial in the insect control industry and widely seen as convenient for homeowners.

### BRIEF DESCRIPTION OF THE DRAWINGS

The drawings illustrate the best mode presently contemplated for carrying out the invention.

FIG. 1 illustrates side and top plan views of a cover portion of an acoustic wave insect-trapping condenser according to one aspect of the present invention;

FIG. 2 is a rear view of the insect-trapping condenser and a rear view of the cover portion of FIG. 1;

FIG. 3 is a side view of the insect-trapping condenser;

FIG. 4 is a schematic view of one embodiment of an acoustic wave generation system for use with the insect-trapping condenser;

FIG. 5 is one embodiment of a display for a programmable thermostat for use with the insect-trapping condenser;

FIG. 6 is a side view of another embodiment of an insect-trapping device; and

FIG. 7 is a sectional view of another embodiment of the insect-trapping device.

### DETAILED DESCRIPTION OF THE INVENTION

The purpose of this invention is to rid a residential home of mosquitoes in the outside recreational areas.

This invention reduces insects, such as mosquitoes (e.g., mosquitoes carrying viruses such as the West Nile virus), in the home environment. The advancement of this invention is in the insect trapping and condenser technologies. Advantageously, the combination of these devices results in large scale or quantity eradication of such insects.

The condenser includes fins that can be conveniently rid of trapped insects simply by washing or rinsing the fins of insects. Insects can be conveniently drawn to collection locations done by repelling and attracting means used to achieve the desired effect.

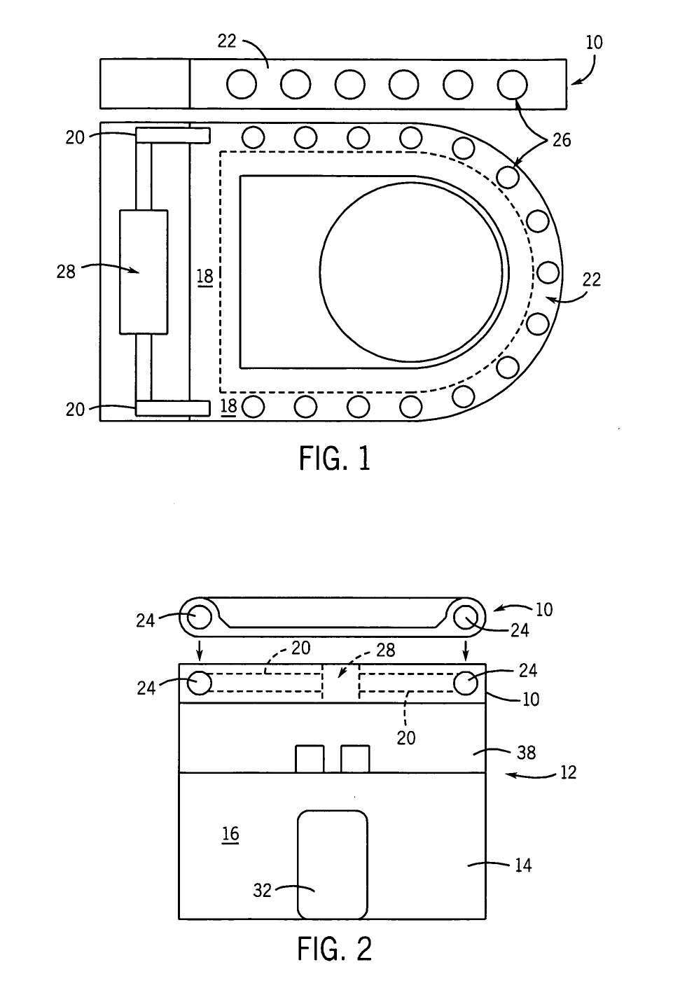

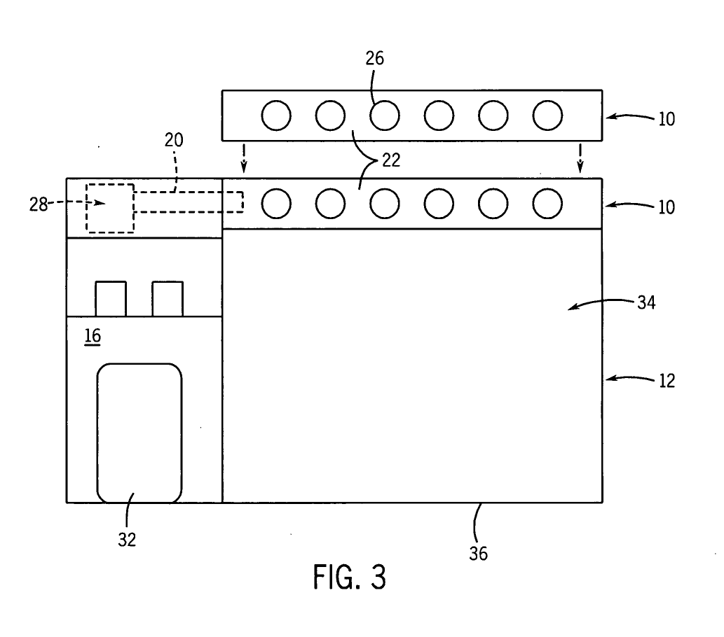

FIGS. 1-3 illustrate side, rear and top plan views of a cover 10 of an acoustic wave insect-trapping condenser 12, as well as rear and side views of the insect-trapping condenser. The acoustic wave insect-trapping condenser comprises a main housing 14 which defines a main housing interior 16. In the embodiment shown, the cover portion is adapted to fit on the main housing. The condenser also includes a housing cover 10 connected to the main housing 14, the housing cover defining a housing cover interior 18 having a manifold 20. The condenser further includes a baffle 22 located within the housing cover interior 18 in communication with the manifold 20, the baffle having a plurality of baffle channels 24. The channels terminate in acoustic wave outlets 26. An acoustic wave generation system 28 is in operational association with the baffle 22 for generating insect-attracting acoustic soundwaves at an insect-attracting frequency and distributing, that is, pipes the soundwaves, via the manifold 20 into the plurality of baffle channels 24. The condenser also includes a compressor 30 located within the main housing interior 16 for compressing a refrigerant and a fin arrangement 34 located within the main housing interior for trapping insects attracted by the insect-attracting soundwaves generated by the acoustic wave generation system. The fin arrangement 34 comprises a plurality of fins 36 arranged in a substantially vertical fashion. In one embodiment, the fin arrangement is adapted to receive a chemical insect attractant. One attractant suitable for use in the present invention is octanol. The chemical scent keeps the insects actively seeking the condenser 12. The condenser can further comprise a motor and fan blade housing 38 having an interior 40 for housing a motor and fan, the motor for driving movement of the fan. Acoustic waves that are generated by the acoustic wave generation system 28 travel through manifold 20 and subsequently enter the baffle 22 and exit out of the wave outlets 26 and into the ambient air in the vicinity of the condenser. The fins are utilized to trap or capture insects. Advantageously, the insects are easily cleaned from the fins.

The condenser, or insect trapping system, can be said to comprise means for generating insect-attracting acoustic soundwaves at an insect-attracting frequency and means for drawing and trapping insects into a condenser. The system can also be said to include means for drawing and trapping insects into a condenser, and said drawing and trapping means can further comprise a fin arrangement comprising a plurality of fins arranged in a substantially vertical fashion. The means for drawing and trapping insects into the condenser can further comprise a fan for drawing air out of the condenser via a vacuum.

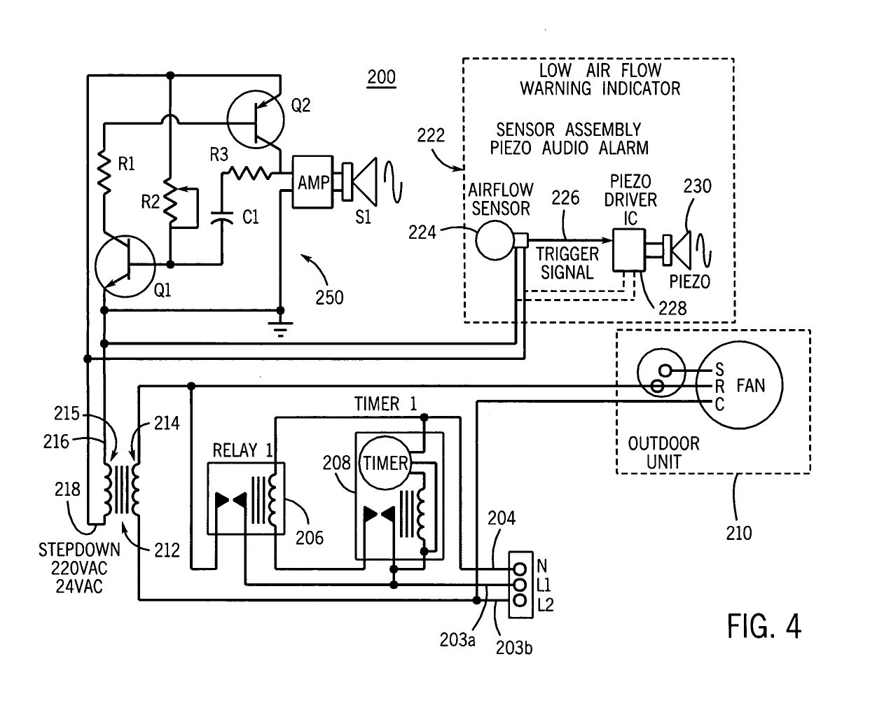

FIG. 4 is a schematic view of one embodiment of an acoustic wave generation system 200 for use with the insect-trapping condenser. A line voltage (for example 240VAC) is provided at power source 202, which includes two power lines 203a and b and a neutral line 204. Line LI (203a) and a neutral line 204 is tied to a relay 206 and timer 208 as part of a switching and timing network for controlling timing of the acoustic soundwaves. In one embodiment, the timer is part of a T-STAT device. Power is also provided to fan unit 210.

The acoustic wave generation system 200 further includes a sonic wave circuit 250 for providing the insect-attracting acoustic soundwaves. The circuit as shown and described in U.S. Pat. No. 3,888,233, the disclosure of which is incorporated by reference herein. It is understood that the configuration and components shown can vary to achieve the same or similar desired electrical responses and switching sequences.

The pulse generating circuit 250 is an oscillator circuit which will, in operation, generate pulses as long as power is provided. Because the line voltage in this case will be too high to operate circuit 250, it will be necessary to “step down” the voltage with stepdown transformer 212. Stepdown transformer 212 takes the line voltage at high voltage side 214 and steps down the voltage by coil windings. The stepdown voltage (for example 24VAC) is supplied at the low voltage side 215 via one terminal 216 of stepdown transformer 212 to the emitter of NPN transistor Q1 and via the other terminal 218 of stepdown transformer 212 to the emitter of PNP transistor Q2. Amplifier (Amp) and speaker S1 are connected between ground and the collector of transistor Q2. The amplification needed can vary depending on the noise desired to overcome (e.g., 1 Watt of Amplification) in order to “cancel out” the noise of the ambient area. The more noise desired to overcome, the higher the amplification needed. Because a fan for drawing air out of the condenser via a vacuum is used, the acoustic wave generation system includes an amplifier for amplifying the insect-attracting acoustic soundwaves so as to cancel substantially any noise created by the fan.

Connected in series between the collector of transistor Q2 and the base of transistor Q1 is capacitor C1 and resistor R3. R2, which provides variable resistance, is connected from the base of transistor Q1 to the emitter of transistor Q2. Resistor R1 is connected from the collector of transistor Q1 to the base of transistor Q2. The emitter of transistor Q1 is tied to ground.

In operation, capacitor C1 is charged through the circuit path provided resistor R2, capacitor C1, resistor R3, and speaker S1. Generally, variable resistor R2 will be set to determine the charging rate of capacitor C1. In other words, the setting of the variable resistor R2 will determine the time delay between cycles of the oscillator and the cycle rate can be set by changing the resistance of R2.

Capacitor C1 is charged until a voltage is stored on the side common to Q1 to forward bias the base-emitter junction of Q1. When the base-emitter junction of Q1 is forward biased, the collector emitter current path of Q1 is biased into a conductive state. Thereby, the base-emitter junction of Q2 is forward biased to switch Q2 into a conductive state. With both transistors Q1 and Q2 in a conductive state, a current flow through collector-emitter path of Q2 to generate a first pulse through amplifier (all of the signals passing to S1 are amplified by the amplifier) and ultimately to speaker S1 to provide a pulse of sound. A smaller current flows from the collector of Q2 through R3 to charge the plate of capacitor C1 common with R3. A current flows through the emitter-collector path of Q1 and the resistor R1 such that a voltage on the base of Q2 increases to now reverse bias the emitter-base junction of Q2 and switch Q2 to a non-conductive state. A current also flows through the emitter-base path of Q1 to discharge the plate of C1 common to the base of Q1 until the capacitor plate is sufficiently discharged to reverse bias the base-emitter junction of Q1 and switch Q1 non-conductive state. When both Q1 and Q2 are non-conductive, the charge accumulated on the plate of C1 common with R3 discharges through the current path defined by R3 and the speaker S1 to generate a second sound pulse, with this pulse smaller than the first. This combination of pulses is repeated to simulate a heart beating, and has a range of about 50-500 cps (cycles per second), including the range of a human heart.

Connected to the circuitry of the acoustic wave generation system 200 and associated with the condenser is a low airflow warning indicator 222 capable of sensing air flowing through the fin arrangement and transmitting an audible alarm when the airflow falls below a predetermined airflow rate. An airflow sensor 224, which is supplied the stepped down voltage, when it senses an airflow below the predetermined airflow rate, sends a trigger signal on line 226 to the driver IC 228, which is used to provide the proper signal to the audio alarm 230, in the embodiment shown, a Piezo audio alarm signal. The net result is the monitoring of airflow to identify when the unit needs cleaning.

The system can be said to include means for generating insect attracting acoustic soundwaves, and the generating means can include a sonic wave circuit for providing the insect-attracting acoustic soundwaves. The means can further include a relay and timer for controlling timing of the acoustic soundwaves.

In one embodiment, a self cleaning model of the invention is contemplated by using a fan is reversible to self clean by reversal of the fan spin direction, which forces the air into a pressure cone, carrying with it the insects trapped and deceased insects from the fins by evacuation.

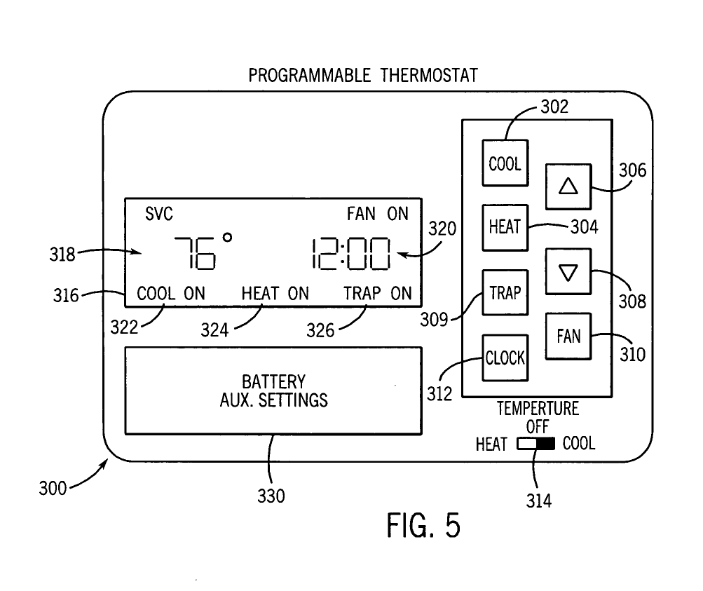

FIG. 5 is one embodiment of a display for a programmable thermostat for use with the insect-trapping condenser. The condenser of claim 1 further comprises a programmable thermostat 300 for controlling at least one condenser setting. The programmable thermostat 300 includes a cooling 302 setting and heating 304 setting with increase controls 306, decrease 308 controls and a trap control 309. There is a fan button 310 to circulate the fan and a clock 312 and typical heat/cool/off control 314. On display 316, information regarding temperature 318, time 320 and status information on cooling 322, heating 324, trap 326 and fan status 328. Additional controls, such as the battery status and auxiliary settings are on display 330.

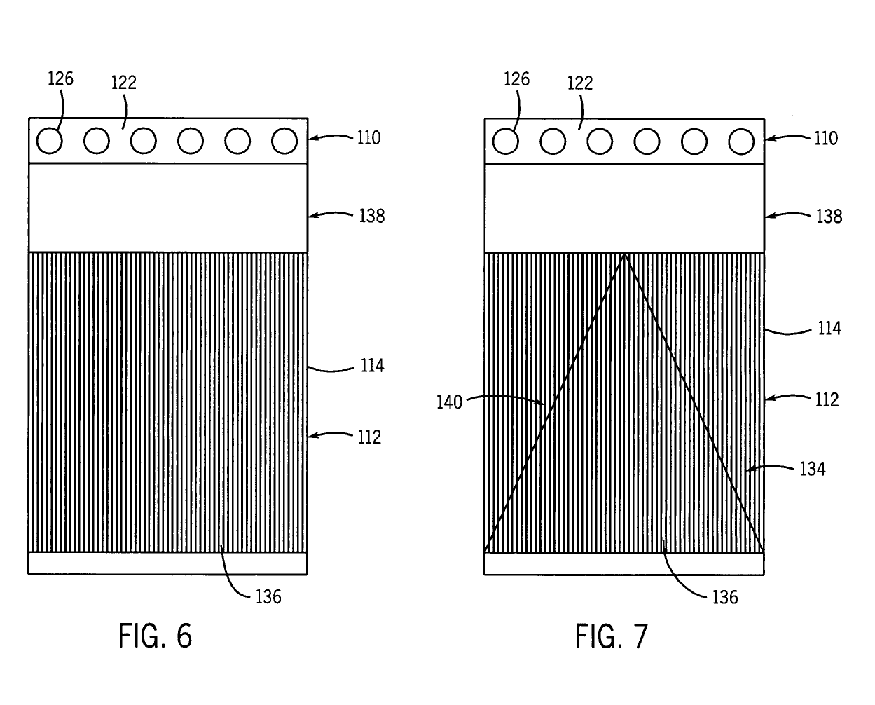

FIGS. 6-7 are side and sectional views of another embodiment of an insect-trapping device 112. In this embodiment, the components and functionality are similar to the insect trapping device as shown and described with respect to FIGS. 1-3. Here, however, the device does not require utilization of a refrigeration process, or more particularly, a compressor for compressing a refrigerant. The device 112 includes a cover 110, a baffle 122 and acoustic wave outlets 126. A fin arrangement 134 comprises a plurality of fins 136 arranged in a substantially vertical fashion. As shown in FIG. 7, the plurality of fins can comprise an insect evacuation and air pressure cone 140. In this embodiment as before, the fin arrangement can be adapted to receive a chemical insect attractant, for example, octanol. The device can further comprise a motor and fan blade housing 138 for housing a motor and fan, the motor for driving movement of the fan. The fins are utilized to trap or capture insects. Advantageously, the insects are easily cleaned from the fins. While not shown, the fins can, in addition to their substantial vertical arrangement, be arranged in a “zig-zag” pattern so as to attract insects. In a preferred embodiment, the fins are colored so that they are dark.

Also disclosed is a method of trapping insects using a condenser. The method comprises providing an acoustic wave generating system in combination with a condenser having a fin arrangement with a plurality of fins. The method further comprises generating insect-attracting acoustic soundwaves at an insect-attracting frequency and drawing, to the fin arrangement, insects into the condenser so as to trap the insects at the plurality of fins using the insect-attracting acoustic soundwaves generated at the insect-attracting frequency. The method further comprises sensing, using a low airflow warning indicator, air flowing through the fin arrangement and transmitting an audible alarm when the airflow falls below a predetermined airflow rate. In one embodiment, the method includes drawing, using a fan, air out of the condenser via a vacuum. In one embodiment, method includes amplifying, using an amplifier in association with the acoustic wave generation system, the insect-attracting acoustic soundwaves so as to cancel substantially any noise created by the fan. In another embodiment, the method comprises providing, using a sonic wave circuit, the insect-attracting acoustic soundwaves, and controlling, using a relay and timer, timing of the acoustic soundwaves.

The invention can be used at the convenience of the homeowner with an in-house thermostat and outside warning indicator to alert the user to clean the unit prior to unit inefficiency.

The benefits of the present invention inure to power companies and users alike. Users tend to have inefficient units with dirty condensers resulting in higher utility bills. Additional costs for a change-out of condenser and a thermostat have been known to range from about $200 to $300. Also, high temperatures generated from clogged operation results in high costs to users, costs which are mitigated from the frequent cleaning.

Other devices that use sonic waves with a partial vacuum combined with chemicals and a gluey substance to collect the insects and that use CO₂ and heat with a partial vacuum include U.S. Pat. Nos. 6,467,215 and 5,241,778, which are incorporated herein by reference. Prior products require items such as a gluey substance being used to capture insects. Insects are drawn into the condenser fins, trapping and finally killing the insects by suffocation. Advantageously, in the current invention clean-up is simple and there is no need to replace things such as a sticky substance to collect the insects

One of the benefits contrary to teachings in the art is getting the user to not only clean the unit when called for, but also getting the user to clean the unit on a regular basis, as this increases the efficiency of the refrigeration process. One of the benefits that will occur from this invention will be the reduction of insects in a given location, and an increase in efficiency in the refrigeration process upon regular cleaning. In other words, the homeowner is given additional incentive to clean the filtration system on an ongoing basis. Utility bills are likely to be reduced.

This invention is a combination condensing unit and sonic wave insect control device. The invention as described can be combined easily into an existing condensing unit as a retrofit. By transforming the hood of the unit into a baffling housing, piping the acoustic sound waves into the baffling hood, mounting the electrical components in the unit arranged in a general fashion as in drawings, along with a chemical attractant and a repeller.

In the testing of this invention a sonic emitter can be placed in the condensing unit. A combination of a chemical attractant like Octanol can be added to the airflow of the condensing unit. Placing of the attractant should be placed in a dispenser saturated in a sponge and moderately released.

In one application in residential homes recreational area, the condensing unit may be placed at one side of the home and a repeller at the other. It can have a cycling rate above 500 cps thus sending the insects from one side of the house to the attraction zone of the other.

The present invention has been described in terms of preferred embodiments. Equivalents, alternatives, and modifications, aside from those expressly stated herein, are possible and should be understood to be within the scope of the appending claims.

1. An acoustic wave insect-trapping condenser comprising:
a main housing defining a main housing interior;
a housing cover connected to the main housing, the housing cover defining a housing cover interior having a manifold;
a baffle located within the housing cover interior in communication with the manifold, the baffle having a plurality of baffle channels;
an acoustic wave generation system in operational association with the baffle for generating insect-attracting acoustic soundwaves at an insect-attracting frequency and distributing the soundwaves via the manifold into the plurality of baffle channels;
a compressor within the main housing interior for compressing a refrigerant; and
a fin arrangement within the main housing interior for trapping insects attracted by the insect-attracting soundwaves generated by the acoustic wave generation system.

2. The condenser of claim 1 further including a low airflow warning indicator capable of sensing air flowing through the fin arrangement and transmitting an audible alarm when the airflow falls below a predetermined airflow rate.

3. The condenser of claim 1 wherein the fin arrangement comprises a plurality of fins arranged in a substantially vertical fashion.

4. The condenser of claim 1 further comprising a fan for drawing air out of the condenser via a vacuum and wherein the acoustic wave generation system includes an amplifier for amplifying the insect-attracting acoustic soundwaves so as to cancel substantially any noise created by the fan.

5. The condenser of claim 1 wherein the acoustic wave generation system further includes a sonic wave circuit for providing the insect-attracting acoustic soundwaves, and a relay and timer for controlling timing of the acoustic soundwaves.

6. The condenser of claim 5 wherein the timer is a T-STAT device.

7. The condenser of claim 1 wherein the fin arrangement is adapted to receive a chemical insect attractant.

8. The condenser of claim 7 wherein the attractant is octanol.

9. The condenser of claim 1 further comprising a motor and fan blade housing having an interior for housing a motor and fan, the motor for driving movement of the fan.

10. The condenser of claim 1 further comprising a programmable thermostat for controlling at least one condenser setting.

11. The condenser of claim 3 wherein the plurality of fins comprising an insect evacuation and air pressure cone.

12. A method of trapping insects using a condenser, the method comprising:
providing an acoustic wave generating system in combination with a condenser having a fin arrangement with a plurality of fins;
generating insect-attracting acoustic soundwaves at an insect-attracting frequency;
drawing, to the fin arrangement, insects into the condenser so as to trap the insects at the plurality of fins using the insect-attracting acoustic soundwaves generated at the insect-attracting frequency.

13. The method of claim 12 further comprising sensing, using a low airflow warning indicator, air flowing through the fin arrangement and transmitting an audible alarm when the airflow falls below a predetermined airflow rate.

14. The method of claim 12 further comprising drawing, using a fan, air out of the condenser via a vacuum.

15. The method of claim 14 further comprising amplifying, using an amplifier in association with the acoustic wave generation system, the insect-attracting acoustic soundwaves so as to cancel substantially any noise created by the fan.

16. The method of claim 12 further comprising providing, using a sonic wave circuit, the insect-attracting acoustic soundwaves, and controlling, using a relay and timer, timing of the acoustic soundwaves.

17. A system for trapping insects, the system comprising:
means for generating insect-attracting acoustic soundwaves at an insect-attracting frequency; and
means for drawing and trapping insects into a condenser.

18. The system of claim 17 wherein the means for generating insect attracting acoustic soundwaves includes a sonic wave circuit for providing the insect-attracting acoustic soundwaves, and a relay and timer for controlling timing of the acoustic soundwaves.

19. The system of claim 17 wherein the means for drawing and trapping insects into a condenser further comprises a fin arrangement comprising a plurality of fins arranged in a substantially vertical fashion.

20. The system of claim 19 wherein the means for drawing and trapping insects into the condenser further comprises fan for drawing air out of the condenser via a vacuum.

21. An acoustic wave insect-trapping device comprising:
a main housing defining a main housing interior;
a housing cover connected to the main housing, the housing cover defining a housing cover interior having a manifold;
a baffle located within the housing cover interior in communication with the manifold, the baffle having a plurality of baffle channels;
an acoustic wave generation system in operational association with the baffle for generating insect-attracting acoustic soundwaves at an insect-attracting frequency and distributing the soundwaves via the manifold into the plurality of baffle channels; and
a fin arrangement within the main housing interior for trapping insects attracted by the insect-attracting soundwaves generated by the acoustic wave generation system.
